(19) United States
(12) Patent Application Publication
(10) Pub. No.: US 2002/0138327 A1
(43) Pub. Date: Sep. 26, 2002

(54) System for remotely managing elevator mechanic service routine

(76) Inventors: Celso Luis Mello, West Hartford, CT (US); Jonathan Spinelli, Southington, CT (US); Jeff Hastings, East Longmeadow, MA (US); Edward Curvino, Canton, CT (US); Gerrit Lachaert, Nossegem (BE); David Leah, Haslemere (GB); Geoff O. Morrin, Eastwood (AU)

Correspondence Address: David J. Gaskey, CARLSON, GASKEY & OLDS. P.C., 400 West Maple Road, Suite 350, Birmingham, MI, 48009, US

(21) Appl. No.: 09/818,016

(22) Filed: Mar. 26, 2001

(51) Int. Cl. G06F 17/60

(52) U.S. Cl. 705/9

(57) ABSTRACT

A system for assisting elevator mechanics at completing the various tasks during a work day provides remote and automatic access to various kinds of information and communications. A planning module provides a prioritized task list for the mechanic to follow through the day. An information module provides the mechanic access to various types of safety, technical and location information to help the mechanic to arrive at locations and complete tasks in a more efficient manner. A communications module facilitates communication between the mechanic and elevator service company base locations through wireless communication links.

### BACKGROUND OF THE INVENTION

This invention generally relates to assisting an elevator mechanic at managing daily activities and completing work assignments.

Elevator systems often require maintenance or, in some instances, repair. Elevator mechanics typically travel to many different locations to service the various elevators as needed. During a typical day, a mechanic must travel to various locations, perform different types of maintenance or repair tasks, obtain various kinds of technical information and maintain billing record information. Additionally, mechanics typically need to facilitate ordering parts to make certain repairs or replacements.

Performing all of the various tasks efficiently and effectively presents a challenge to each mechanic. Additionally, elevator service companies desire to provide the best possible customer service, which requires effective management of the various mechanics' time and efforts.

There is a need for a system that facilitates an elevator mechanic completing the various tasks during a work day in a more effective and efficient manner. This invention provides such a system.

### SUMMARY OF THE INVENTION

In general terms, this invention is a system that assists an elevator mechanic in completing the various tasks required during a normal work day. A system designed according to this invention includes a planning module that automatically plans out a recommended list of tasks for the mechanic to complete during the work day. An information module automatically provides the mechanic information regarding items associated with the recommended list of tasks. A communication module facilitates communication between the mechanic and a base location. A portable mechanic interface is operative to allow the mechanic to remotely interact with the planning, information and communication modules, respectively.

In the preferred embodiment, the system includes software that accomplishes the tasks of the planning, communication and information modules, respectively. The portable mechanic interface may be a handheld device using wireless communication or a device mounted within a mechanic's vehicle, for example. The interface preferably includes a display screen and a mechanism for the mechanic to input information or access information through the interface.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 diagrammatically illustrates a system designed according to this invention.

FIG. 2 schematically illustrates more details regarding portions of the system of FIG. 1.

### DETAILED DESCRIPTION OF A PREFERRED EMBODIMENT

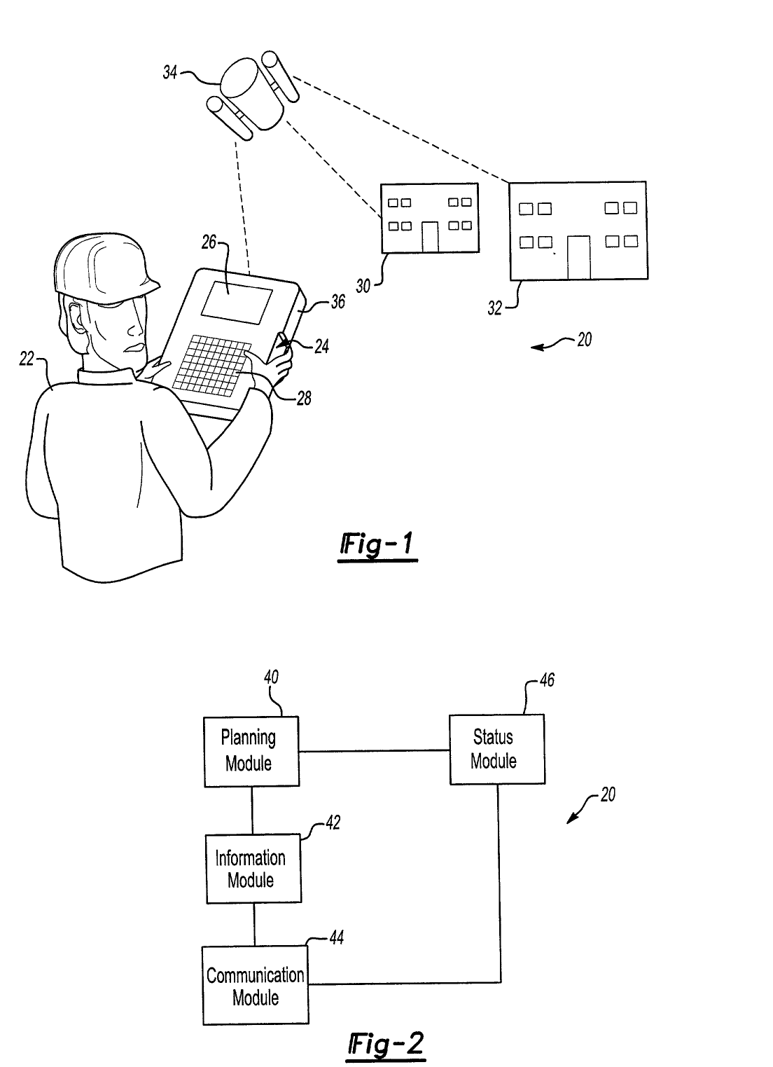

A system 20 for automatically and remotely assisting an elevator mechanic 22 completing the various tasks required during a normal work day provides the mechanic 22 with information and communication abilities at any necessary remote location. The system 20 preferably includes a portable interface device 24 that provides the mechanic with automatic access to various types of information as described below. The interface device 24 may be a hand held device as illustrated in FIG. 1. Alternatively, the portable interface device may be mounted within a mechanic's vehicle. The interface device 24 preferably includes a display screen 26 and an input mechanism 28 such as a keyboard. Alternatively, the display screen 26 may be a touch screen that allows the mechanic to utilize conventional touch screen technology for entering information or obtaining information.

The interface device 24 permits the mechanic 22 to remotely communicate with one or more base locations 30 and 32. The illustrated example includes wireless communication with a satellite link 34. Alternatively communication can be accomplished through cellular phone or radio frequency channels. Using the portable interface device 24, the mechanic 22 is able to obtain information located at the base locations 30, 32 and to communicate information back to appropriate personnel or record keeping devices at those various locations.

The portable interface device 24 preferably includes a tracking component 36 that provides position information regarding the location of the device 24 and, therefore, the mechanic 22. Conventional global positioning technology is useful for this purpose. Having the information regarding the location of the mechanic assists the system 20 in planning out a recommended routine for the mechanic and in managing various customer requests for repair or maintenance visits.

As schematically illustrated in FIG. 2, the system 20 preferably includes several operative components, which are referred to in this specification as modules. While separate modules are illustrated for discussion purposes, it must be understood that there is not necessarily any physical or software distinction between them in a system designed according to this invention. For example, the software that accomplishes tasks described as part of the planning module 40 may also accomplish some of the tasks of other modules described in this specification. The distinction between the modules is for discussion purposes only. Those skilled in the art who have the benefit of this description will be able to develop the necessary software code for accomplishing the results provided by this invention.

The system 20 preferably includes a planning module 40 that automatically plans out a recommended list of tasks or routine for the mechanic to complete during a workday. The planning module primarily provides scheduling information to the mechanic. The planning module 40 preferably utilizes information generated at a base location regarding requests for service or repair at various locations. The planning module preferably automatically prompts the mechanic 22 to accept or decline a particular task for a given day. The planning module preferably automatically prioritizes the various tasks accepted by each mechanic so that the mechanic has a listing in the order of preference for which jobs are to be done before others.

The prioritization provided by the planning module 40 preferably takes into account at least one of several variables. One such variable is the nature of the task required by the elevator mechanic. Some customer requests, for example when a passenger is stuck in an elevator, require more immediate attention than others. The planning module 40 preferably provides the mechanic with information regarding the type of task to be completed and the priority or proposed schedule deadline. Additionally, the planning module 40 preferably utilizes information regarding the location where various jobs are to be completed as part of organizing the mechanic's day. The planning module 40 preferably takes into account location information to minimize mechanic drive time, for example.

The planning module 40 preferably also updates the prioritized list of tasks through the day as various mechanics accomplish various tasks within a certain region. Additionally, as new customer requests are received at a base location, those preferably are communicated to the mechanic and inserted into an updated prioritized list as may be useful or necessary through the day.

An information module 42 preferably provides the mechanic with automatic access to information regarding various aspects of elevator systems. Example types of information include technical information regarding an elevator system at a particular location, elevator system history information that may be obtainable through a database, building information regarding the installation of the particular elevator system, safety information regarding safety measures to be taken before performing a repair or service operation and troubleshooting information suggesting potential solutions to problems based upon the mechanic's observations and input to the system 20. Of course, other types of information may be provided through the information module 42. Those skilled in the art who have the benefit of this description will realize the various types of information that are useful for a mechanic to have ready access to during the workday for more completely and quickly completing the various tasks as needed at any given location.

A communication module 44 facilitates communication between the mechanic 22 and the personnel or devices located at a base location. One type of information preferably provided by the mechanic to the base location is status information regarding the various tasks that the mechanic is attempting to complete through the day. A status module 46 preferably processes the actual status information regarding whether a task is completed, for example. The mechanic 22 preferably is able to quickly and easily, through the interface device 24, provide information to the base location regarding the completion of a task, a description of the work performed by the mechanic in completing the task, any requests for components needed to complete a task and opportunities for further possible work to be performed at a given location. The system 20 preferably prompts the mechanic 22 through a series of questions to determine whether there is an opportunity for further service business at a given location given the nature of the customer's contract and the condition of the elevator system at a given location, for example.

The system 20 facilitates more efficient and more effective service from elevator mechanics traveling to various locations to perform a variety of service or repair tasks through a work day. The communication module 44 preferably synchronizes and updates information provided to the mechanic at the interface device 24 and a corresponding database at a base location. Such automatic updating of information not only enhances the mechanic's ability to manage a workday, but further increases the ability for the elevator service company to better organize and deploy various mechanics to various locations to service customers in the best possible manner.

An example use of a system designed according to this invention includes the mechanic 22 logging onto the system using the interface device 24. The elevator service company system at the base location 30 obtains the mechanic's location using the locating device 36 and a known wireless network triangulation method or global positioning technology. The location information regarding the mechanic and the interface device 24 preferably is continuously updated as long as the mechanic 22 is logged onto the system 20. The system at the base location preferably provides an updated suggested route based on the assigned tasks, which have been accepted by the mechanic, and traffic information to facilitate more quick travel to the various locations by the mechanic. The suggested task list for the day preferably is automatically presented to the mechanic as a default screen. The presented task list preferably sorts the tasks automatically taking into consideration the priority, deadline, distance and nature of the task. In one example, a graphical driving map also is provided to the mechanic in the event that the mechanic needs directions or when the mechanic may decide to perform some tasks out of the order presented.

The system allows the mechanic to select a task and automatically review details regarding the task and any changes in status while traveling to the location. Included in the information automatically provided to the mechanic preferably is safety procedures and any other special instructions, such as building entrance codes. Information regarding the particular elevator system such as the unit's history preferably is also readily displayable for review by the mechanic. 22. Upon arrival at the site, the system 20 preferably updates the status of the customer request to “in process” or “working” status, for example. This may automatically be done by the system based upon the location information regarding the locator device 36.

While the mechanic is at the service location, the system 20 provides the mechanic with options of obtaining various types of technical information through the interface device 24. Examples include troubleshooting information, which preferably is provided in an interactive form in response to information provided by the mechanic or selections on a menu, for example. The system 20 preferably also facilitates the mechanic communicating with a live, on-line expert for troubleshooting advice through the interface 24. The system 20 preferably also prompts the mechanic to enter in the solution information that the mechanic used for purposes of updating the system database on possible solutions, given the diagnosis of the problem, and to keep the service company's history of the service of the particular elevator system accurate.

Other types of technical information available to the mechanic during a call include specifications, recommended safety procedures, and other technical details regarding the various components or system that the elevator mechanic is working on.

At the end of the task, the mechanic 22 preferably uses the interface device 24 to close out the task. Upon close out, the system 20 preferably automatically calculates travel time and work time and presents that information to the mechanic in the form of a time ticket that is reviewed and approved (or altered if necessary) using the interface device 24. Additionally, the system 20 preferably allows the mechanic to enter expenses to account for parts that were utilized, for example.

When necessary, the mechanic is able to order parts using the interface 24. The system 20 preferably presents the mechanic with graphical representations of the particular unit schematics so that the mechanic can simply pick from the screen which components are necessary. The system 20 then preferably automatically checks for availability at nearby storage locations, which may include other machine rooms, or other mechanic's vehicles, before the parts are back-ordered.

The system 20 preferably also, upon close out, prompts the mechanic to answer questions regarding whether there are possibilities for additional revenue generation at the particular location. Depending on the input provided by the mechanic, the system 20 preferably automatically forwards information to an appropriate portion of the company's sales force for estimation and negotiation with the customer. The interface 24 facilitates keeping the mechanic advised of the progress of that potential lead over time.

Additionally, upon close out, the system 20 preferably updates the mechanic's prioritized task list and adds any nearby tasks as the next task if that appears reasonable. Additionally, the prioritized task list preferably is updated based upon recent customer inquiries or changes in priorities of particular requests.

One feature of the interface device 24 preferably is to provide an indicator (visual or audible) to the mechanic each time that a priority customer call is placed. In one example, the interface device 24 sounds an alarm and prompts the mechanic to accept or reject the particular call. If the mechanic accepts it, preferably an estimated time of arrival is entered by the mechanic. The system 20 preferably provides a brief assessment of the situation to the mechanic so that the mechanic is able to determine whether immediate attention is required.

Additional features preferably are provided to facilitate the mechanic more readily completing the tasks during a work day. Such features include providing driving directions, providing contractual information regarding the type of service contract at a particular location, technical documentation and updates, incoming email messages, the ability to send outgoing email messages, the ability to contact the service center or other mechanics, access to the internet or a company intranet, maintaining a technical skill profile regarding each mechanic and providing the ability to request training based upon presented proposed training schedules. Lastly, the system 20 preferably allows the mechanic to provide work schedule information such as leaves of absence, vacations, sick days, etc.

Given this description, those skilled in the art will be able to choose from among commercially available components and devices and to write the necessary software code to program such devices to accomplish the results provided by this invention.

The preceding description is exemplary rather than limiting in nature. Variations and modifications to the disclosed embodiment may become apparent to those skilled in the art that do not necessarily depart from the purview and spirit of this invention. The scope of legal protection given to this invention can only be determined by studying the following claims.

1. A system for automatically and remotely assisting an elevator mechanic, comprising:
a planning module that automatically plans out a recommended list of tasks for the mechanic to complete during a workday;
an information module that automatically provides the mechanic information regarding items associated with the recommended routine;
a communication module that facilitates communication between the mechanic and a base location; and
a portable mechanic interface that is operative to allow the mechanic to remotely access information from the planning, information and communication modules, respectively.

2. The system of claim 1, including a tracking device that automatically provides information regarding a location of the mechanic and wherein the planning module uses the location information.

3. The system of claim 2, wherein the tracking device is associated with the portable interface.

4. The system of claim 2, including a status module that maintains information regarding a status of a task, the status module periodically updating the status of a task responsive to information from the tracking device.

5. The system of claim 1, wherein the planning module provides information to the mechanic regarding a plurality of tasks to be performed, a recommended order in which to perform the tasks and information regarding a location where each task is to be performed.

6. The system of claim 5, including using location information regarding the tasks to determine the recommended order.

7. The system of claim 1, wherein the planning module is operative to provide a prioritized order of tasks to be completed during the workday.

8. The system of claim 7, wherein the planning module periodically updates the prioritized order of tasks.

9. The system of claim 1, wherein the information module provides at least one type of information to the mechanic, the type of information being at least one of technical information regarding elevator system components, building information regarding a location of an elevator system, safety information regarding procedures to be performed, data regarding a history of elevator system performance, or troubleshooting information.

10. The system of claim 1, wherein the communication module facilitates the mechanic providing a base location with information regarding a status of a task that the mechanic is undertaking.

11. The system of claim 10, wherein the communication module facilitates the mechanic providing information to the base location regarding at least one of a completion of a task, a description of work performed by the mechanic in completing a task, requests for components needed to complete a task, and opportunities for further work to be performed at a selected location.

12. The system of claim 10, wherein the communication module automatically generates billing information regarding a task completed by the mechanic.

13. A method of automatically and remotely assisting an elevator mechanic, comprising the steps of:
(A) automatically planning out a recommended list of tasks for the mechanic to complete during a workday;
(B) automatically providing the mechanic information regarding items associated with the recommended routine responsive to an inquiry from the mechanic; and
(C) facilitating remote communication between the mechanic and a base location whereby the mechanic is able to access information regarding the recommended list of step (A) and the information of step (B).

14. The method of claim 13, including determining a location of the mechanic and wherein step (A) includes using information regarding the determined location.

15. The method of claim 14, including maintaining status information regarding a status of a task and periodically updating the status of a task using the determined location.

16. The method of claim 13, including assigning a priority level to the tasks of step (A) and automatically periodically updating the priority level.

17. The method of claim 13, wherein step (B) includes providing at least one type of information to the mechanic, the type of information being at least one of technical information regarding elevator system components, building information regarding a location of an elevator system, safety information regarding procedures to be performed, data regarding a history of elevator system performance, or troubleshooting information.

18. The method of claim 13, including automatically processing information from the mechanic regarding a status of a task that the mechanic is undertaking.

19. The method of claim 18, including processing information regarding at least one of a completion of a task, a description of work performed by the mechanic in completing a task, requests for components needed to complete a task, and opportunities for further work to be performed at a selected location.

20. The method of claim 13, including automatically generating billing information regarding a task completed by the mechanic.
